(19) United States
(12) Patent Application Publication
(10) Pub. No.: US 2026/0173205 A1
(43) Pub. Date: Jun. 18, 2026

(54) METHOD AND APPARATUS FOR SIGNAL TRANSMISSION BASED ON DISCONTINUOUS TRANSMISSION OPERATION IN COMMUNICATION SYSTEM

(71) Applicant: Electronics and Telecommunications Research Institute, Daejeon (KR)

(72) Inventors: Sung-Hyun MOON, Daejeon (KR); Ji Hyung KIM, Daejeon (KR); Cheulsoon KIM, Daejeon (KR); Junghoon LEE, Daejeon (KR); Hoiyoon JUNG, Daejeon (KR); Jung-Bin KIM, Daejeon (KR); Gyeongrae IM, Daejeon (KR)

(21) Appl. No.: 19/373,461

(22) Filed: Oct. 29, 2025

(30) Foreign Application Priority Data
Oct. 29, 2024 (KR) 10-2024-0149747
Oct. 22, 2025 (KR) 10-2025-0153358

(51) Int. Cl. H04W 76/28

(52) U.S. Cl. CPC H04W 76/28

(57) ABSTRACT

Disclosed are signal transmission method and apparatuses based on DTX operations in a communication system. A method of a terminal may comprise: receiving, from a base station, information indicating a first DTX active time; receiving, from the base station, information indicating a second DTX active time; and performing communication with the base station based on at least one of the first DTX active time or the second DTX active time.

### CROSS-REFERENCE TO RELATED APPLICATIONS

This application claims priority to Korean Patent Applications No. 10-2024-0149747, filed on Oct. 29, 2024, and No. 10-2025-0153358, filed on Oct. 22, 2025, with the Korean Intellectual Property Office (KIPO), the entire contents of which are hereby incorporated by reference.

### BACKGROUND

### 1. Technical Field

The present disclosure relates to a signal transmission technique, and more particularly, to a discontinuous transmission (DTX) operation-based signal transmission technique.

### 2. Related Art

A next-generation communication system (e.g., a new radio (NR) communication system or a 6G communication system) is expected to serve as a core infrastructure for the proliferation of convergence services in which various future industries are integrated. The next-generation communication system can support not only conventional mobile communication frequency bands but also millimeter-wave bands, terahertz bands, and upper-mid bands. The next-generation communication system can support more diverse performance indicators and scenarios than conventional communication systems (e.g., LTE communication systems). The next-generation communication system is expected to support ultra-long-distance communication such as non-terrestrial networks. For the next-generation communication system, technologies for compensating radio path loss and technologies for expanding cell coverage are required. In particular, a radio resource management method supporting beam hopping operations for compensating for insufficient transmission power of a satellite node is required.

### SUMMARY

The present disclosure for resolving the above-described problems is directed to providing a method and apparatus for signal transmission based on DTX operations in a communication system.

A method of a terminal, according to exemplary embodiments of the present disclosure, may comprise: receiving, from a base station, information indicating a first discontinuous transmission (DTX) active time; receiving, from the base station, information indicating a second DTX active time; and performing communication with the base station based on at least one of the first DTX active time or the second DTX active time.

The first DTX active time may be configured periodically, and the second DTX active time may be configured aperiodically.

The second DTX active time may be opportunistically allocated by dynamic signaling of the base station.

The information indicating the second DTX active time may be included in downlink control information (DCI) received from the base station, and the information indicating the second DTX active time may include at least one of a start time, a duration, or an end time of the second DTX active time.

An end time of the second DTX active time may be extended as needed.

The first DTX active time and the second DTX active time may be applied in different radio resource control (RRC) states, and each of the different RRC states may be an RRC idle mode, an RRC inactive mode, or an RRC connected mode.

The terminal in an RRC connected mode may apply the second DTX active time, and the terminal in an RRC idle mode or an RRC inactive mode may not apply the second DTX active time.

The performing of the communication with the base station may comprise: transmitting and receiving, with the base station, a first signal allowed for one of the first DTX active time or the second DTX active time, during an overlapped time between the first DTX active time and the second DTX active time.

The first DTX active time may not overlap with the second DTX active time, the second DTX active time may be terminated at a reference time, and the reference time may be determined based on a specific time for the first DTX active time.

The first DTX active time may not overlap with the second DTX active time, a resource pool for the second DTX active time may be configured, the second DTX active time may be activated within the resource pool, and the second DTX active time may be deactivated outside the resource pool.

A method of a base station, according to exemplary embodiments of the present disclosure, may comprise: transmitting, to a terminal, information indicating a first discontinuous transmission (DTX) active time; transmitting, to the terminal, information indicating a second DTX active time; and performing communication with the terminal based on at least one of the first DTX active time or the second DTX active time.

The first DTX active time may be configured periodically, and the second DTX active time may be configured aperiodically.

The second DTX active time may be opportunistically allocated to the terminal by dynamic signaling of the base station.

The information indicating the second DTX active time may be included in downlink control information (DCI) transmitted by the base station, and the information indicating the second DTX active time may include at least one of a start time, a duration, or an end time of the second DTX active time.

An end time of the second DTX active time may be extended as needed.

The first DTX active time and the second DTX active time may be applied in different radio resource control (RRC) states, and each of the different RRC states may be an RRC idle mode, an RRC inactive mode, or an RRC connected mode.

The second DTX active time may be applied to the terminal in an RRC connected mode, and the second DTX active time may not be applied to the terminal in an RRC idle mode or an RRC inactive mode.

The performing of the communication with the terminal may comprise: transmitting and receiving, with the terminal, a first signal allowed for one of the first DTX active time or the second DTX active time, during an overlapped time between the first DTX active time and the second DTX active time.

The first DTX active time may not overlap with the second DTX active time, the second DTX active time may be terminated at a reference time, and the reference time may be determined based on a specific time for the first DTX active time.

The first DTX active time may not overlap with the second DTX active time, a resource pool for the second DTX active time may be configured, the second DTX active time may be activated within the resource pool, and the second DTX active time may be deactivated outside the resource pool.

According to the present disclosure, a terminal may receive information on a first DTX active time and information on a second DTX active time from a base station, and may perform communication with the base station based on at least one of the first DTX active time or the second DTX active time. Based on the above-described operation, in a situation in which a plurality of DTX active times are configured, operations of the base station and/or the terminal can be clearly defined, and DTX-based communication can be efficiently performed. Accordingly, performance of a communication system can be improved.

### BRIEF DESCRIPTION OF DRAWINGS

FIG. 1 is a conceptual diagram illustrating exemplary embodiments of a communication system.

FIG. 2 is a block diagram illustrating exemplary embodiments of an apparatus.

FIG. 3 is a conceptual diagram illustrating exemplary embodiments of a non-terrestrial network.

FIG. 4 is a conceptual diagram illustrating exemplary embodiments of a beam hopping method of a satellite node.

FIG. 5 is a conceptual diagram illustrating exemplary embodiments of a DTX operation method.

FIG. 6 is a conceptual diagram illustrating exemplary embodiments of a method of configuring a plurality of cell DTX active times having a common cycle.

FIG. 7 is a conceptual diagram illustrating exemplary embodiments of a method of configuring a plurality of cell DTX active times having independent cycles.

FIG. 8 is a conceptual diagram illustrating exemplary embodiments of a method of allocating an aperiodic cell DTX active time.

FIG. 9 is a conceptual diagram illustrating exemplary embodiments of a signal transmission method based on overlapping cell DTX active times.

FIG. 10 is a conceptual diagram illustrating exemplary embodiments of a method of configuring a resource pool for a cell DTX active time.

FIG. 11 is a conceptual diagram illustrating a first exemplary embodiment of a beam-specific cell DTX configuration method.

FIG. 12 is a conceptual diagram illustrating a second exemplary embodiment of a beam-specific cell DTX configuration method.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system may be the 4G communication system (e.g., Long-Term Evolution (LTE) communication system or LTE-A communication system), the 5G communication system (e.g., New Radio (NR) communication system), the sixth generation (6G) communication system, or the like. The 4G communication system may support communications in a frequency band of 6 GHz or below, and the 5G communication system may support communications in a frequency band of 6 GHz or above as well as the frequency band of 6 GHz or below. The communication system to which the exemplary embodiments according to the present disclosure are applied is not limited to the contents described below, and the exemplary embodiments according to the present disclosure may be applied to various communication systems. Here, the communication system may be used in the same sense as a communication network, ‘LTE’ may refer to ‘4G communication system’, ‘LTE communication system’, or ‘LTE-A communication system’, and ‘NR’ may refer to ‘5G communication system’ or ‘NR communication system’.

In exemplary embodiments, ‘configuration of an operation (e.g., transmission operation)’ may mean ‘signaling of configuration information (e.g., information element(s), parameter(s)) for the operation’ and/or ‘signaling of information indicating performing of the operation’. In other words, ‘an operation (e.g., transmission operation) being configured in a communication node’ may mean that the communication node receives ‘configuration information (e.g., information element, parameter) for the operation’ and/or ‘information indicating to perform the operation’. ‘An information element (e.g., parameter) being configured in a communication node’ may mean that the information element is signaled to the communication node (e.g., the communication node receives the information element)′. Signaling may be at least one of system information (SI) signaling (e.g., transmission of a system information block (SIB) and/or master information block (MIB)), RRC signaling (e.g., transmission of RRC parameters and/or higher layer parameters), MAC control element (CE) signaling, or PHY signaling (e.g., transmission of downlink control information (DCI), uplink control information (UCI), and/or sidelink control information (SCI)). A message for SI signaling may be referred to as an SI message, a message for RRC signaling may be referred to as an RRC message, a message for MAC CE signaling may be referred to as a MAC message, and a message for PHY signaling may be referred to as a PHY message. The above-described messages may be expressed as a first message, a second message, a third message, and so on.

In the present disclosure, a phrase including “when ˜” may be expressed as a phrase including “based on ˜” or a phrase including “in response to ˜”. In other words, a phrase including “when ˜” may be interpreted as being identical or similar to a phrase including “based on ˜” or a phrase including “in response to ˜”.

In the present disclosure, a ‘time’ may mean a time point, and ‘time’ and ‘time point’ may be used with the same meaning. A reception time of a signal or channel may mean a reception start time or a reception end time. A transmission time of a signal or channel may mean a transmission start time or a transmission end time.

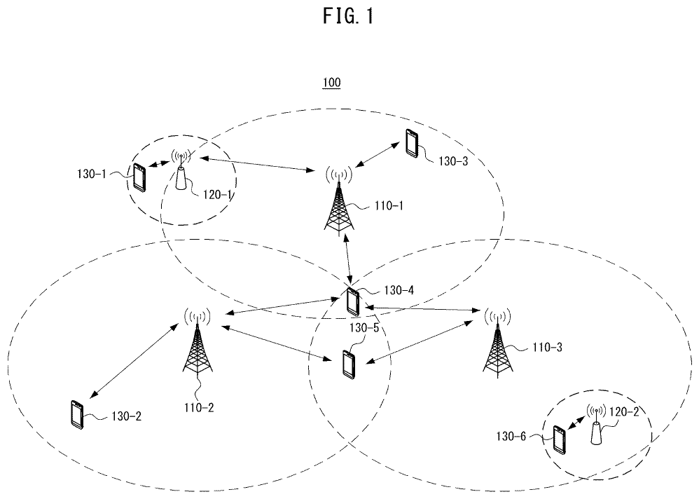

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may further comprise a core network (e.g., a serving gateway (S-GW), a packet data network (PDN) gateway (P-GW), and a mobility management entity (MME)). When the communication system 100 is a 5G communication system (e.g., New Radio (NR) system), the core network may include an access and mobility management function (AMF), a user plane function (UPF), a session management function (SMF), and the like.

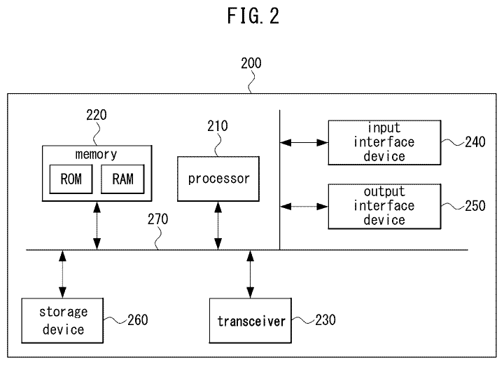

The plurality of communication nodes 110 to 130 may support communication protocols defined in the 3rd generation partnership project (3GPP) technical specifications (e.g., LTE communication protocol, LTE-A communication protocol, NR communication protocol, or the like). The plurality of communication nodes 110 to 130 may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may mean an apparatus or a device. Exemplary embodiments may be performed by an apparatus or device. A structure of the apparatus (or, device) may be as follows. FIG. 2 is a block diagram illustrating exemplary embodiments of an apparatus.

Referring to FIG. 2, an apparatus 200 may comprise at least one processor 210, a memory 220, and a transceiver 230 connected to the network for performing communications. Also, the apparatus 200 may further comprise an input interface device 240, an output interface device 250, a storage device 260, and the like. The respective components included in the apparatus 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

Each of the first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

A numerology applied to physical signals and channels in the communication system (e.g., NR communication system or 6G communication system) may be variable. The numerology may vary to satisfy various technical requirements of the communication system. In the communication system to which a cyclic prefix (CP) based OFDM waveform technology is applied, the numerology may include a subcarrier spacing and a CP length (or CP type). Table 1 below may be a first exemplary embodiment of configuration of numerologies for the CP-based OFDM. The subcarrier spacings may have an exponential multiplication relationship of 2, and the CP length may be scaled at the same ratio as the OFDM symbol length. Depending on a frequency band in which the communication system operates, at least some numerologies among the numerologies of Table 1 may be supported. In addition, in the communication system, numerologies not listed in Table 1 may be further supported. CP type(s) not listed in Table 1 (e.g., extended CP) may be additionally supported for a specific subcarrier spacing (e.g., 60 kHz).

TABLE 1

| | Subcarrier spacing | | | | | |
|---|---|---|---|---|---|---|
| | 15 | 30 | 60 | 120 | 240 | 480 |
| | kHz | kHz | kHz | kHz | kHz | kHz |
| OFDM symbol | 66.7 | 33.3 | 6.7 | 8.3 | 4.2 | 2.1 |
| length [μs] | | | | | | |
| CP length [μs] | 4.76 | 2.38 | 1.19 | 0.60 | 0.30 | 0.15 |
| Number of | 14 | 28 | 56 | 112 | 224 | 448 |
| OFDM symbols | | | | | | |
| within 1 ms | | | | | | |

In the following description, a frame structure in the communication system will be described. In the time domain, elements constituting a frame structure may include a subframe, slot, mini-slot, symbol, and the like. The subframe may be used as a unit for transmission, measurement, and the like, and the length of the subframe may have a fixed value (e.g., 1 ms) regardless of a subcarrier spacing. A slot may comprise consecutive symbols (e.g., 14 OFDM symbols). The length of the slot may be variable differently from the length of the subframe. For example, the length of the slot may be inversely proportional to the subcarrier spacing.

A slot may be used as a unit for transmission, measurement, scheduling, resource configuration, timing (e.g., scheduling timing, hybrid automatic repeat request (HARQ) timing, channel state information (CSI) measurement and reporting timing, etc.), and the like. The length of an actual time resource used for transmission, measurement, scheduling, resource configuration, etc. may not match the length of a slot. A mini-slot may include consecutive symbol(s), and the length of a mini-slot may be shorter than the length of a slot. A mini-slot may be used as a unit for transmission, measurement, scheduling, resource configuration, timing, and the like. A mini-slot (e.g., the length of a mini-slot, a mini-slot boundary, etc.) may be predefined in the technical specification. Alternatively, a mini-slot (e.g., the length of a mini-slot, a mini-slot boundary, etc.) may be configured (or indicated) to the terminal. When a specific condition is satisfied, use of a mini-slot may be configured (or indicated) to the terminal.

The base station may schedule a data channel (e.g., physical downlink shared channel (PDSCH), physical uplink shared channel (PUSCH), physical sidelink shared channel (PSSCH)) using some or all of symbols constituting a slot. In particular, for URLLC transmission, unlicensed band transmission, transmission in a situation where an NR communication system and an LTE communication system coexist, and multi-user scheduling based on analog beamforming, a data channel may be transmitted using a portion of a slot. In addition, the base station may schedule a data channel using a plurality of slots. In addition, the base station may schedule a data channel using at least one mini-slot.

In the frequency domain, elements constituting the frame structure may include a resource block (RB), subcarrier, and the like. One RB may include consecutive subcarriers (e.g., 12 subcarriers). The number of subcarriers constituting one RB may be constant regardless of a numerology. In this case, a bandwidth occupied by one RB may be proportional to a subcarrier spacing of a numerology. An RB may be used as a transmission and resource allocation unit for a data channel, control channel, and the like. Resource allocation of a data channel may be performed in units of RBs or RB groups (e.g., resource block group (RBG)). One RBG may include one or more consecutive RBs. Resource allocation of a control channel may be performed in units of control channel elements (CCEs). One CCE may include one or more RBs in the frequency domain.

In the communication system (e.g., NR communication system), the above-described unit time resource (hereinafter, ‘slot’) may be composed of a combination of one or more of downlink period, flexible period (or unknown period), and an uplink period. Each of a downlink period, flexible period, and uplink period may be comprised of one or more consecutive symbols. A flexible period may be located between a downlink period and an uplink period, between a first downlink period and a second downlink period, or between a first uplink period and a second uplink period. When a flexible period is inserted between a downlink period and an uplink period, the flexible period may be used as a guard period.

A slot may include one or more flexible periods. Alternatively, a slot may not include a flexible period. The terminal may perform a predefined operation in a flexible period. Alternatively, the terminal may perform an operation configured by the base station semi-statically or periodically. For example, the periodic operation configured by the base station may include a PDCCH monitoring operation, synchronization signal/physical broadcast channel (SS/PBCH) block reception and measurement operation, channel state information-reference signal (CSI-RS) reception and measurement operation, downlink semi-persistent scheduling (SPS) PDSCH reception operation, sounding reference signal (SRS) transmission operation, physical random access channel (PRACH) transmission operation, periodically-configured PUCCH transmission operation, PUSCH transmission operation according to a configured grant, and the like. A flexible symbol may be overridden by a downlink symbol or an uplink symbol. When a flexible symbol is overridden by a downlink or uplink symbol, the terminal may perform a new operation instead of the existing operation in the corresponding flexible symbol (e.g., overridden flexible symbol).

In the present disclosure, an SSB may refer to a signal set including synchronization signals and/or a broadcast channel. The synchronization signals may include a PSS, SSS, etc., and the broadcast channel may include a physical broadcast channel (PBCH). The SSB may further include a reference signal. Reference signals (e.g., reference signal included in the SSB) include a demodulation reference signal (DM-RS) for decoding of the PBCH, CSI-RS, tracking reference signal (TRS), positioning reference signal (PRS), phase tracking reference signal (PT-RS), and the like. In the NR communication system, the SSB may refer to a synchronization signal/physical broadcast channel (SS/PBCH) block. SSBs may be transmitted periodically, and one or more SSB(s) may be transmitted repeatedly in one cycle.

A format of the unit time resource (hereinafter, ‘slot format’) may be configured semi-statically by higher layer signaling (e.g., radio resource control (RRC) signaling). Information indicating a semi-static slot format may be included in system information, and the semi-static slot format may be configured in a cell-specific manner. In addition, a semi-static slot format may be additionally configured for each terminal through terminal-specific higher layer signaling (e.g., RRC signaling). A flexible symbol of a slot format configured cell-specifically may be overridden by a downlink symbol or an uplink symbol by terminal-specific higher layer signaling. In addition, a slot format may be dynamically indicated by physical layer signaling (e.g., slot format indicator (SFI) included in downlink control information (DCI)). The semi-statically configured slot format may be overridden by a dynamically indicated slot format. For example, a semi-static flexible symbol may be overridden by a downlink symbol or an uplink symbol by SFI.

The terminal may perform downlink operations, uplink operations, and sidelink operations in a bandwidth part. A bandwidth part may be defined as a set of consecutive RBs (e.g., physical resource blocks (PRBs)) having a specific numerology in the frequency domain. One numerology may be used for transmission of signals (e.g., transmission of control channel or data channel) in one bandwidth part. In the present disclosure, when used in a broad sense, a ‘signal’ may refer to any physical signal and channel. A terminal performing an initial access procedure may obtain configuration information of an initial bandwidth part from the base station through system information. A terminal operating in an RRC connected state may obtain the configuration information of the bandwidth part from the base station through terminal-specific higher layer signaling.

The configuration information of the bandwidth part may include a numerology and/or an RB set applied to the bandwidth part. At least one bandwidth part among the bandwidth part(s) configured in the terminal may be activated. For example, within one carrier, one uplink bandwidth part and one downlink bandwidth part may be activated respectively. In a time division duplex (TDD) based communication system, a pair of an uplink bandwidth part and a downlink bandwidth part may be activated. The base station may configure a plurality of bandwidth parts to the terminal within one carrier, and may switch the active bandwidth part of the terminal.

In exemplary embodiments, ‘a certain frequency band (e.g., carrier, bandwidth part, RB set, listen before talk (LBT) subband, guard band, etc.) is activated’ may mean that the base station or terminal is in a state where signals can be transmitted and received using the frequency band. Further, ‘a certain frequency band is activated’ may mean that a radio frequency (RF) filter (e.g., band-pass filter) of a transceiver is in a state of operating including the frequency band.

In exemplary embodiments, an RB may mean a common RB (CRB). Alternatively, an RB may mean a PRB or a virtual RB (VRB). In the communication system (e.g., NR communication system), a CRB may refer to an RB constituting a set of consecutive RBs (e.g., common RB grid) based on a reference frequency (e.g., point A). Carriers, bandwidth parts, and the like may be arranged on the common RB grid. In other words, a carrier, bandwidth part, etc. may be composed of CRB(s). An RB or CRB constituting a bandwidth part may be referred to as a PRB, and a CRB index within the bandwidth part may be appropriately converted into a PRB index. In an exemplary embodiment, an RB may refer to an interlace RB (IRB).

A PDCCH may be used to transmit a DCI or DCI format to the terminal. A minimum resource unit constituting a PDCCH may be a resource element group (REG). An REG may be composed of one PRB in the frequency domain and one OFDM symbol in the time domain. A demodulation reference signal (DMRS) for demodulating a PDCCH may be mapped to some REs among REs constituting the REG, and control information (e.g., modulated DCI) may be mapped to the remaining REs. One PDCCH candidate may be composed of one CCE or aggregated CCEs. One CCE may be composed of a plurality of REGs. The NR communication system may support CCE aggregation levels 1, 2, 4, 8, 16, and the like, and one CCE may consist of 6 REGs.

A control resource set (CORESET) may be a resource region in which the terminal performs a blind decoding on PDCCHs. The CORESET may be composed of a plurality of REGs. The CORESET may consist of one or more RBs in the frequency domain and one or more symbols (e.g., OFDM symbols) in the time domain. The symbols constituting one CORESET may be consecutive in the time domain. The RBs constituting one CORESET may be consecutive or non-consecutive in the frequency domain. One DCI (e.g., one DCI formation, one PDCCH) may be transmitted within one CORESET. A plurality of CORESETs may be configured with respect to a cell and a terminal, and time/frequency resource regions to which the plurality of CORESETs are mapped may or may not overlap with each other.

A CORESET may be configured in the terminal during an initial access procedure. For example, a CORESET may be configured in the terminal by an initial access signal (e.g., a PBCH or system information transmitted on the PBCH). An identifier (ID) of the CORESET configured by the initial access signal may be 0. The CORESET configured by the initial access signal may be referred to as a CORESET 0. A terminal operating in the RRC idle state may perform a monitoring operation in the CORESET 0 in order to receive an initial PDCCH in the initial access procedure. Not only terminals operating in the RRC idle state but also terminals operating in the RRC connected state may perform monitoring operations in the CORESET 0. The CORESET may be configured in the terminal by other system information (e.g., system information block type 1 (SIB1)) other than the system information transmitted through the initial access signal (e.g., PBCH). For example, for reception of a random access response (or Msg2), the terminal may receive the SIB1 including the configuration information of the CORESET. The CORESET may be configured in the terminal by terminal-specific higher layer signaling (e.g., RRC signaling).

A search space may be a set of candidate resource regions in which PDCCHs can be transmitted. The terminal may perform a blind decoding on each of PDCCH candidates within a predefined search space or a search space configured by the base station. The terminal may determine whether a PDCCH is transmitted to itself by performing a cyclic redundancy check (CRC) on a result of the blind decoding. When it is determined that a PDCCH is a PDCCH for the terminal itself, the terminal may receive the PDCCH.

One or more search space(s) may constitute a search space set. The search space may be defined/configured for each CCE aggregation level, and the search space set may mean a search space for each CCE aggregation level or a sum of search spaces for all CCE aggregation levels. For each CCE aggregation level, a PDCCH candidate may consist of CCE(s) selected by a predefined hash function within the CORESET or search space occasion. In exemplary embodiments, ‘search space set’ may refer to ‘search space’.

A search space set may be logically associated (e.g., combined) with one CORESET. One CORESET may be logically associated with one or more search space sets. A common search space set configured by the PBCH may be used to monitor a DCI that schedules a PDSCH for carrying the SIB1. An ID of the common search space set configured by the PBCH may be set to 0. In other words, the common search space set configured by the PBCH may be defined as a Type 0 PDCCH common search space set or search space set #0. The search space set #0 may be logically associated with the CORESET 0.

The search space sets may be classified into common search space sets and terminal-specific search space sets (i.e., UE-specific search space sets) depending on their purposes or operations of the terminal. A common DCI or a terminal-specific DCI (e.g., UE-specific DCI) may be transmitted in a common search space set, and a terminal-specific DCI may be transmitted in a terminal-specific search space set (e.g., UE-specific search space set). For example, the common DCI may include resource allocation information of a PDSCH including system information, paging messages, etc., power control command, slot format indicator (SFI), and/or preemption indicator. The terminal-specific DCI may include resource allocation information of a PDSCH and/or resource allocation information of a PUSCH. A plurality of DCI formats may be defined depending on the purposes, and the plurality of DCI formats may be distinguished by the terminal by a DCI payload, DCI field, DCI size, and/or radio network temporary identifier (RNTI).

In the present disclosure, a common search space may be referred to as a CSS, and a common search space set may be referred to as a CSS set. A terminal-specific search space may be referred to as a UE-specific search space (USS), and a terminal-specific search space set may be referred to as a USS set.

The terminal may assume that a PDCCH DM-RS has a quasi-co-location (QCL) relationship with a certain signal (e.g., SSB, CSI-RS, PDSCH DM-RS, PDCCH DM-RS, etc.). The PDCCH DM-RS may refer to a DM-RS used for modulation and/or demodulation of a PDCCH. The PDSCH DM-RS may refer to a DM-RS used for modulation and/or demodulation of a PDSCH. Since the PDCCH has the same antenna port as the PDCCH DM-RS, the PDCCH and the PDCCH DM-RS may have a QCL relationship. Through the QCL assumption, the terminal may obtain information on large-scale propagation characteristics of a wireless channel experienced by the PDCCH and the PDCCH DM-RS and may utilize the large-scale propagation characteristics of the wireless channel for channel estimation and reception beamforming. QCL parameters may include at least one of delay spread, Doppler spread, Doppler shift, average gain, average delay, or spatial reception (Rx) parameters. The spatial reception parameters may correspond to at least one of a reception beam, a reception channel spatial correlation, or a pair of transmission and reception beams. The spatial reception parameters may be referred to as ‘spatial QCL’. The PDCCH may be used in a sense that includes the PDCCH DM-RS. The statement that a PDCCH has a QCL relationship with a certain signal may include a meaning that a DM-RS of the PDCCH has a QCL relationship with the certain signal. A signal having a QCL relationship with a PDCCH or a resource of the signal may be referred to as a QCL source, a QCL source signal, or a QCL source resource.

PDCCHs transmitted in the same CORESET (e.g., search space sets, PDCCH monitoring occasions, etc. corresponding to the same CORESET) may have the same QCL relationship. In other words, a unit for which the terminal assumes the same QCL may be a CORESET, and QCL assumption may be independent for each CORESET. In exemplary embodiments, a QCL and a QCL source of a certain CORESET may refer to a QCL and a QCL source of a PDCCH received through the corresponding CORESET, respectively. Exceptionally, different QCL assumptions may be applied to search space sets corresponding to a single CORESET. For example, a search space set (e.g., Type 1 CSS set) for monitoring a random access (RA)-RNTI and a search space set other than the aforementioned search space set may have different QCL relationships.

A QCL relationship or QCL assumption (e.g., QCL source, QCL type, etc.) of a CORESET may be determined by a predefined method. For example, the terminal may assume that a PDCCH DM-RS received through a certain CORESET or a certain search space set has a QCL relationship with an SSB and/or CSI-RS selected in an initial access or random access procedure for a predefined QCL type. The QCL type may refer to a set of one or more QCL parameters. A QCL relationship or QCL assumption (e.g., QCL source, QCL type, etc.) of a CORESET may be signaled by base station to the terminal (e.g., through RRC signaling, MAC control element (CE) signaling, DCI signaling, or a combination thereof). In other words, the base station may configure a transmission configuration indication (TCI) state for the CORESET in the terminal. Generally, a TCI state may include at least one of an ID of a signal (e.g., a QCL source or QCL source resource of a PDCCH DM-RS) having a QCL relationship with a DM-RS of a physical channel (e.g., the PDCCH DM-RS) to which a TCI is applied or a QCL type for the signal. For example, the base station may configure one or more TCI state candidates for each CORESET through RRC signaling and may indicate (e.g., configure) one of the TCI state candidates to be used for CORESET monitoring of the terminal through MAC signaling (or DCI signaling). If only one TCI state candidate is configured through RRC signaling, the MAC signaling procedure (or DCI signaling procedure) may be omitted. The terminal may perform PDCCH monitoring and reception operations for the corresponding CORESET based on the TCI state configuration information received from the base station.

In the present disclosure, a TCI state may be referred to as a TCI for convenience. While a TCI generally refers to a broad concept that includes a beam or signaling information related to the beam, in the present disclosure, it may be used in a sense corresponding to a beam. A downlink TCI or a TCI for receiving a downlink signal may correspond to a reception beam, whereas an uplink TCI or a TCI for transmitting an uplink signal may correspond to a transmission beam. The transmission beam may refer to spatial relation information, a transmission spatial filter, or the like.

Meanwhile, a next-generation communication system may support a non-terrestrial network (NTN) in order to provide a stable communication environment even in shadow areas and disaster situations. The NTN may provide wireless communication services from the air to the ground by using high altitude platform stations (HAPS), satellites, and/or the like. The satellites may be classified, according to altitude, into low earth orbit (LEO), medium earth orbit (MEO), geostationary earth orbit (GEO), highly elliptical orbit (HEO) satellites, or the like. The satellites may be classified, according to an orbital location, into geostationary satellites and non-geostationary satellites.

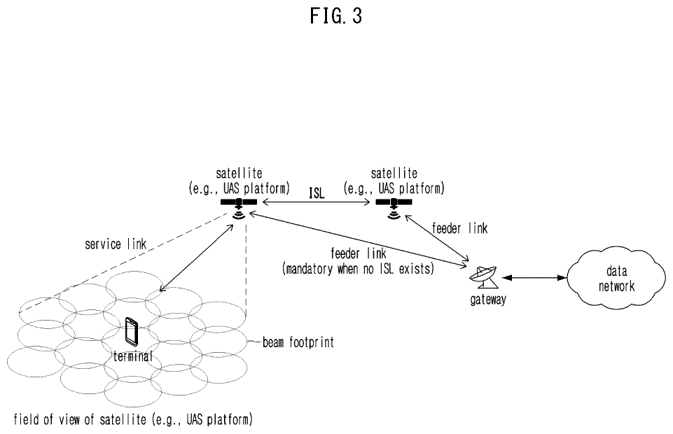

FIG. 3 is a conceptual diagram illustrating exemplary embodiments of a non-terrestrial network.

Referring to FIG. 3, service areas of a satellite node (or an unmanned aircraft system (UAS) platform) may be formed within a field of view of the satellite. The satellite node may form a plurality of beams. The service areas may be divided based on beam footprints formed as ground reception ranges of the plurality of beams. The satellite node may manage the service areas. A beam may refer to a satellite beam. A beam footprint may be interpreted as a ground coverage area formed by each satellite beam.

Within the service areas of the satellite node, a unique cell ID (e.g., physical cell identifier (PCI)) may be assigned to each of the satellite beams. For example, one satellite beam may correspond to one cell. The satellite node may transmit a synchronization signal block (SSB) having a unique cell ID (e.g., PCI) for each satellite beam. The above scenario may be referred to as a first scenario. Alternatively, the same cell ID may be assigned to a plurality of satellite beams. For example, one cell may include a plurality of satellite beams, and coverage of the cell may correspond to a plurality of beam footprints. The satellite node may transmit different SSBs having the same cell ID for the plurality of satellite beams. Different SSB indexes may be assigned to the different SSBs. The above scenario may be referred to as a second scenario. The correspondence relationship between the cell and satellite beams may not be specified by technical specifications and may be determined by an implementation of a base station. An area of one beam footprint may typically be several tens to several hundreds of kilometers. Since an area of one beam footprint is larger than cell coverage of a terrestrial network, regardless of the correspondence relationship, a terminal may perform a single cell operation while belonging to one beam footprint, based on an SSB and a cell ID corresponding to the beam footprint to which the terminal belongs. Due to mobility of the terminal and/or the satellite node, a handover or a beam switching procedure between beam footprints may be accompanied.

Considering communication performance (e.g., a data rate and a delay) for all terrestrial terminals belonging to a service area, it may be preferable that all satellite beams to which the terminals belong are simultaneously activated. Due to a transmission power limitation of the satellite node, a decrease in received power caused by blockage for the terrestrial terminals, or the like, the number of satellite beams that the satellite node is capable of simultaneously transmitting may be limited. For example, the satellite node may simultaneously activate at most N satellite beams among M satellite beams. Each of M and N may be a natural number. N may be equal to or less than M. Transmission of a beam may refer to transmission of a signal and/or a channel through the beam. Simultaneously activated satellite beams may be transmitted simultaneously. The above-described operation may indicate that at most N beam footprints among M beam footprints can be simultaneously serviced. A value obtained by dividing the number N of satellite beams that can be simultaneously activated in each service area by the total number M of satellite beams may be defined as a coverage ratio. The coverage ratio may vary according to a type of a signal to be transmitted, a link transmission direction (e.g., downlink (DL) or uplink (UL)), or the like. When the coverage ratio is less than 1, the satellite node may perform a beam hopping operation among satellite beams and may provide services by using all beam footprints in a time-division manner. As the coverage ratio increases, more beam footprints can be simultaneously supported, and a dwell time during which a beam stays in each beam footprint may increase.

According to an exemplary embodiment, a default periodicity of SSB may be 20 milliseconds (ms). A base station may transmit SSB every 20 ms in each beam footprint for initial access of a terminal (e.g., a terminal in an RRC idle mode and/or RRC inactive mode). A revisit time of each beam footprint may be at most the periodicity of SSB (i.e., 20 ms). When the coverage ratio is 50 percent, an average dwell time of each beam footprint may be 10 ms. In this case, a terminal connected to a satellite may be provided with a link (e.g., service) for a time duration of 10 ms every 20 ms in a beam footprint to which the terminal belongs. When the coverage ratio decreases to 10 percent, an average dwell time for each beam footprint may decrease to 2 ms in proportion to the coverage ratio. In this case, a terminal may be provided with a service (e.g., a link) only during a time duration of 2 ms every 20 ms. The time duration of 2 ms may be insufficient even to transmit essential common signals such as SSB, SIB1, and SIB19, and unicast transmission may be substantially impossible within 2 ms. Accordingly, in an NTN environment with a low coverage ratio, a short SSB transmission periodicity may act as a large burden.

As a method for solving the above problem, a method of increasing a default SSB periodicity assumed by a terminal may be used. For example, a default SSB periodicity may be defined or configured as 160 ms, 320 ms, 640 ms, or the like.

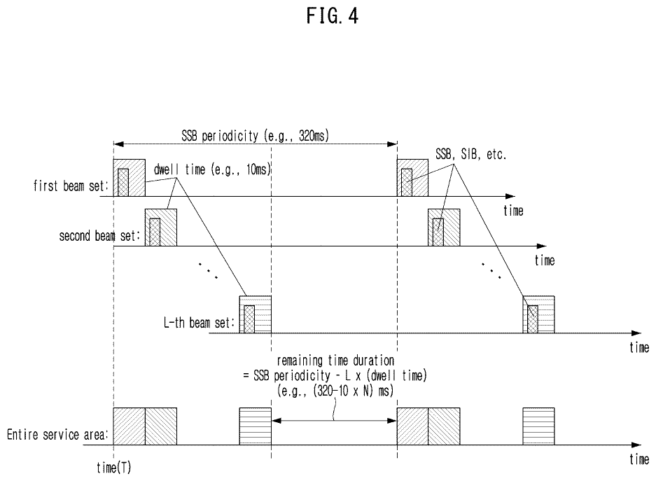

FIG. 4 is a conceptual diagram illustrating exemplary embodiments of a beam hopping method of a satellite node.

Referring to FIG. 4, a service area of a satellite node may be composed of a plurality of beam footprints corresponding to a plurality of satellite beams. In the present disclosure, among the plurality of satellite beams, satellite beams that are simultaneously activated may be referred to, for convenience, as a satellite beam set (or a beam footprint set), and it is assumed that a total of L satellite beam sets may be configured within the service area. L may be a natural number. A transmission periodicity of SSB may be 320 ms. A time duration during which each satellite beam set is activated may be determined in accordance with a transmission periodicity and/or a transmission time of SSB. For example, L satellite beam sets may be sequentially activated in L consecutive time durations. Each of the L time durations may be configured to have a length of 10 ms. Each of the L time durations may correspond to a dwell time of each satellite beam set (e.g., beam footprints corresponding to each satellite beam set). The dwell time may be referred to as a first dwell time. The satellite node may transmit periodic common signals such as SSB and system information (e.g., SIB1 and SIB19) within the first dwell time of each satellite beam. The first dwell time may be periodically repeated according to a periodicity of the common signals. In addition to the periodic common signals, the satellite node may additionally transmit and receive other signals within the first dwell time. The other signals may include a paging signal, PRACH, Msg2, Msg4, a reference signal, a control channel, a data channel, and/or the like.

Within a revisit period of the beam footprints, a remaining time duration may exist except for dwell times of L beam footprints. The remaining time duration may refer to a residual time duration. The remaining time duration may be used for transmission for specific terminal(s) belonging to specific beam footprint(s). The transmission may be periodic or aperiodic. For the transmission, the specific beam footprint(s) may be additionally activated within the remaining time duration, and the additional active duration may be referred to as a second dwell time to be distinguished from the first dwell time. The second dwell time may be temporally discontinuous from the first dwell time.

Characteristics and/or requirements of the first dwell time and the second dwell time may be different from each other. First, the first dwell time may be periodically allocated and repeated for all satellite beams in accordance with transmission of common signals. The second dwell time may be dynamically allocated to specific satellite beam(s) as needed. Second, a repetition periodicity and a length of the first dwell time may be fixed for transmission of periodic signals. In other words, the length of the first dwell time may not be extended. According to traffic characteristics, occurrence of retransmission, or the like, a position and a length of the second dwell time may be dynamically allocated. In other words, the length of the second dwell time may be dynamically changed or extended.

Meanwhile, a terminal may perform communication with the satellite node during a dwell time of a beam footprint to which the terminal belongs (hereinafter referred to as a serving beam footprint). Since the satellite beam corresponding to the serving beam footprint is deactivated during a duration other than the dwell time in order to serve a neighboring beam footprint, communication between the terminal and the satellite node may be impossible. The terminal may not perform a signal transmission operation and/or reception operation during a duration other than the dwell time of the serving beam footprint. The operation of the terminal in each beam footprint and an operation of a base station corresponding to the operation of the terminal may correspond to a discontinuous transmission (DTX) operation and a discontinuous reception (DRX) operation. The dwell time may correspond to a DTX/DRX active time or active duration, and the duration other than the dwell time may correspond to a DTX/DRX inactive time or non-active duration.

The base station (e.g., satellite node) may periodically perform a DTX operation for each beam footprint. The base station may perform a signal transmission operation during a periodically appearing DTX active time of a beam footprint and may not perform a signal transmission operation during a DTX inactive time of the beam footprint. In general, the base station may perform a transmission operation for a first signal set during a DTX active time of a beam footprint and may perform a transmission operation for a second signal set during a DTX inactive time of the beam footprint. Each signal set may be composed of physical signal(s) and/or physical channel(s). The second signal set may be included in the first signal set. For example, the first signal set may include all downlink signals and/or channels transmitted by the base station to the terminal. For example, the second signal set may be an empty set. As another example, the second signal set may include common signals (e.g., SSB and system information). The above-described operation may be referred to as a cell DTX operation. In the present disclosure, ‘DTX’ may be interpreted as ‘cell DTX’ according to a context.

A terminal may perform an operation corresponding to a DTX operation of the base station. The terminal may perform a signal reception operation during a DTX active time of a beam footprint to which the terminal belongs and may not perform a signal reception operation during a DTX inactive time. In general, a terminal may perform a reception operation for the first signal set during a DTX active time of a beam footprint and may perform a reception operation for the second signal set during a DTX inactive time of the beam footprint. In addition to the above-described operation, the terminal may perform a signal blind decoding operation (e.g., PDCCH monitoring operation) during the DTX active time and may not perform a blind decoding operation for at least some signals (e.g., PDCCH monitoring operation) during the DTX inactive time. The operation of the terminal may be referred to as a cell DTX operation. Alternatively, the operation of the terminal may be referred to as a DRX operation from a terminal perspective.

Similarly, the base station (e.g., satellite node) may periodically perform a DRX operation for each beam footprint. The base station may perform a signal reception operation during a periodically appearing DRX active time of a beam footprint and may not perform a signal reception operation during a DRX inactive time of the beam footprint. Alternatively, the base station may perform a reception operation for a third signal set during a DRX active time of a beam footprint and may perform a reception operation for a fourth signal set during a DRX inactive time of the beam footprint. Each signal set may be composed of physical signal(s) and/or channel(s). The fourth signal set may be included in the third signal set. For example, the third signal set may include all uplink signals and/or channels received by the base station from the terminal. For example, the fourth signal set may be an empty set. The above-described operation may be referred to as a cell DRX operation. In the present disclosure, ‘DRX’ may be interpreted as ‘cell DRX’ according to a context.

Similarly, a terminal may perform an operation corresponding to the DRX operation of the base station. The terminal may perform a signal transmission operation during a DRX active time of a beam footprint to which the terminal belongs and may not perform a signal transmission operation during a DRX inactive time of the beam footprint. Alternatively, the terminal may perform a transmission operation for the third signal set during a DRX active time of a beam footprint and may perform a transmission operation for the fourth signal set during a DRX inactive time of the beam footprint. The operation of the terminal may be referred to as a cell DRX operation. Alternatively, the operation of the terminal may be referred to as a DTX operation from a terminal perspective.

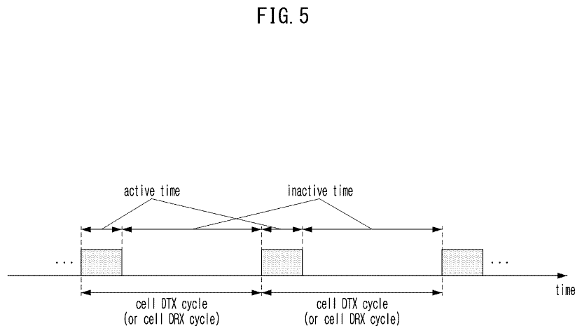

FIG. 5 is a conceptual diagram illustrating exemplary embodiments of a DTX operation method.

Referring to FIG. 5, a base station and a terminal may periodically perform a cell DTX operation (or a cell DRX operation). A cycle of the cell DTX operation (or a cycle of the cell DRX operation) may include an active time and an inactive time, and a cell DTX active time (or a cell DRX active time) and a cell DTX inactive time (or a cell DRX inactive time) may appear periodically and repeatedly. The cell DTX active time (or the cell DRX active time) may be regarded as being arranged at a beginning part of each cycle. Alternatively, the cell DTX active time (or the cell DRX active time) may be arranged in a duration shifted by a preset time offset from a start time of each cycle.

ADTX operation and a DRX operation may be performed in the same carrier. For example, in a TDD system, the base station and the terminal may perform a DTX operation and a DRX operation in the same carrier. Alternatively, the DTX operation and the DRX operation may be performed in different carriers. For example, in an FDD system, the DTX operation and the DRX operation may be performed in a downlink carrier and an uplink carrier, respectively. Alternatively, the DTX operation may be performed in a first carrier (or a first serving cell), and the DRX operation may be performed in a second carrier (or a second serving cell).

The terminal may receive DTX configuration information and/or DRX configuration information from the base station through signaling. The DTX configuration information may include information on a DTX cycle, a start time of a DTX active time (or a time offset within the DTX cycle), a length of the DTX active time, a number of DTX active times, and/or the like, and the DRX configuration information may include information on a DRX cycle, a start time of a DRX active time (or a time offset within the DRX cycle), a length of the DRX active time, a number of DRX active times, and/or the like. Some configuration parameters (e.g., cycle and offset) may be set to the same values for DTX and DRX. At least one of a DTX operation or a DRX operation may be configured for each beam footprint. When the terminal is served by a plurality of beam footprints, a DTX/DRX operation may be configured for each beam footprint.

The beam footprint may correspond to a cell or a carrier. In the present disclosure, performing a DTX/DRX operation for a beam footprint by a base station or a terminal may mean performing a DTX/DRX operation for a cell or a carrier corresponding to the beam footprint. Alternatively, the beam footprint may correspond to a specific beam. For example, the beam footprint may correspond to a satellite beam or an SSB beam, and a plurality of beam footprints corresponding to a plurality of satellite beams or a plurality of SSB beams may belong to the same cell (or carrier). In this case, performing a DTX/DRX operation for a beam footprint by a base station or a terminal may mean performing a DTX/DRX operation for a beam corresponding to the beam footprint. In other words, a DTX/DRX operation may be performed on a beam-by-beam basis (e.g., beam-specifically). The DTX/DRX operation may be commonly applied to a plurality of terminals belonging to the cell, carrier, or beam.

A beam hopping operation of a satellite node may be performed based on a DTX operation and/or a DRX operation. A time duration during which a satellite beam stays in a beam footprint may correspond to a DTX/DRX active time. A terminal belonging to the beam footprint may receive DTX/DRX configuration information including information on the DTX/DRX active time from a base station (e.g., satellite node). The terminal may perform transmission and reception operations during a DTX/DRX active time corresponding to a dwell time of a beam footprint to which the terminal belongs based on the DTX/DRX configuration information and may omit transmission and reception operations during a duration other than the DTX/DRX active time. Alternatively, the terminal may perform a minimum transmission and reception operation during a duration other than the DTX/DRX active time. According to the above method, the terminal may enter a sleep mode and operate at low power during the DTX/DRX inactive time, and battery life of the terminal may increase. In the following exemplary embodiments, a DTX operation is representatively described for convenience of description. However, even without a separate description, the DTX operation described in the present disclosure may be readily interpreted as a DRX operation. In other words, a DRX operation may be performed in the same or a similar manner as the DTX operation to be described later.

According to the above-described exemplary embodiment, a time during which a satellite beam stays in a beam footprint may include the first dwell time and the second dwell time. Each dwell time may correspond to one DTX operation or one DTX active time. The terminal may receive configuration information of a plurality of DTX active times in order to perform a DTX operation for a plurality of dwell times. The terminal may receive configuration information of a first DTX active time corresponding to the first dwell time and configuration information of a second DTX active time corresponding to the second dwell time. The terminal may perform DTX operations for the first DTX active time and the second DTX active time. As methods for configuring a plurality of DTX active times for the terminal, several methods may be considered.

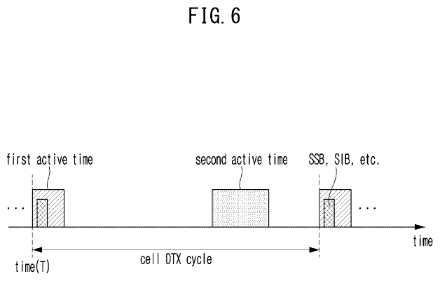

FIG. 6 is a conceptual diagram illustrating exemplary embodiments of a method of configuring a plurality of cell DTX active times having a common cycle.

Referring to FIG. 6, a terminal may receive configuration information of a plurality of cell DTX active times from a base station. A cell DTX/DRX active time may be referred to, for convenience, as an active time when there is no confusion. In other words, in the present disclosure, an ‘active time’ may be interpreted as a ‘cell DTX active time’ or a ‘cell DRX active time’ according to a context. The plurality of cell DTX active times may include the first active time and the second active time. The first active time and the second active time may share the same cell DTX cycle. For example, the first active time may be arranged at a beginning part of a cell DTX cycle, and the second active time may be arranged at a middle part of the cell DTX cycle. In other words, the second active time may be configured after the first active time. A distance from a start time of the cell DTX cycle to each active time may be expressed as a time offset (e.g., a slot offset, a subframe offset, or a symbol offset), and the time offset may be included in cell DTX configuration information. The cell DTX configuration information may be signaled to the terminal. In other words, the base station may transmit DTX configuration information (e.g., cell DTX configuration information) including the time offset and the like to the terminal through signaling. The terminal may receive the DTX configuration information from the base station through signaling.

The plurality of cell DTX active times may be included in one cell DTX configuration (e.g., cell DTX configuration information). The one cell DTX configuration may include information on the cell DTX cycle. The one cell DTX configuration may include the plurality of cell DTX active times sharing the cell DTX cycle. Alternatively, the plurality of cell DTX active times may be respectively included in a plurality of cell DTX configurations. The first active time and the second active time may be respectively included in a first cell DTX configuration and a second cell DTX configuration. A time offset for each cell DTX active time may be included in cell DTX configuration information corresponding to each cell DTX active time. A cell DTX cycle of the first cell DTX configuration and a cell DTX cycle of the second cell DTX configuration may coincide. The cell DTX cycle of the first cell DTX configuration (e.g., a boundary or a start time of the cell DTX cycle) may coincide with the cell DTX cycle of the second cell DTX configuration (e.g., a boundary or a start time of the cell DTX cycle). Alternatively, a start time of each cell DTX active time may be regarded as a start time of a cell DTX cycle corresponding to each cell DTX active time.

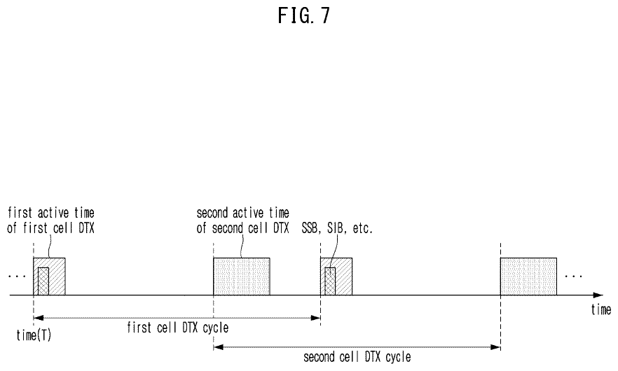

FIG. 7 is a conceptual diagram illustrating exemplary embodiments of a method of configuring a plurality of cell DTX active times having independent cycles.

Referring to FIG. 7, a terminal may receive configuration information of a plurality of cell DTX active times from a base station. The plurality of cell DTX active times may include the first active time and the second active time. The first active time and the second active time may have independent cell DTX cycles. The first active time and the second active time may belong to different cell DTX configurations (e.g., a first cell DTX configuration and a second cell DTX configuration).

The first cell DTX active time and the second cell DTX active time may correspond to different dwell times (e.g., the first dwell time and the second dwell time). Terminal operations in the first active time and the second active time may be different.

An operation of switching the first cell DTX configuration to an activated state or a deactivated state may be performed semi-statically. An operation of switching the second cell DTX configuration to an activated state or a deactivated state may be performed dynamically. The first cell DTX configuration and the second cell DTX configuration may be configured for the terminal based on higher layer signaling (e.g., RRC signaling), and the second cell DTX configuration among the cell DTX configurations may be dynamically switched to an activated state or a deactivated state based on additional dynamic signaling (e.g., DCI and MAC CE). When the plurality of cell DTX configurations are configured for the terminal, a dynamic activation/deactivation indication of a cell DTX configuration may be applied in units of a cell DTX configuration. For example, the terminal may receive DCI in the first active time of the first cell DTX configuration and may identify, based on the DCI, an indication for an activation/deactivation state of the second cell DTX configuration. A separate time duration for monitoring the DCI by the terminal may be configured. The separate time duration may not belong to a cell DTX active time. Even when the separate time duration does not belong to a cell DTX active time, the terminal may exceptionally perform a PDCCH monitoring operation in the separate time duration to receive the DCI. The DCI may be group-common DCI and may be received by a plurality of terminals. The DCI may be DCI format 2_9.

According to another exemplary embodiment, the first cell DTX configuration may be periodically configured, and the second cell DTX configuration may be aperiodically configured. A cell DTX configuration having no periodicity may be configured for the terminal. A cell DTX active time of the aperiodic cell DTX configuration may not appear periodically (e.g., repeatedly).

The cell DTX active time of the aperiodic cell DTX configuration may be opportunistically allocated as needed by dynamic signaling of the base station. In other words, the base station may allocate the cell DTX active time of the aperiodic cell DTX configuration to the terminal as needed. For example, the terminal may receive DCI from the base station and may identify allocation information of the cell DTX active time based on the DCI. The DCI may include information on a time resource occupied by the cell DTX active time. The information may include information on a start time (e.g., a start slot), an end time (e.g., an end slot), a duration (e.g., a number of slots), and/or the like. A part of the information (e.g., the start time and the start slot) may be expressed or interpreted as a time offset (e.g., a slot offset) from a reference time. The reference time may be a time (e.g., a slot) at which the DCI is received. Alternatively, the reference time may be a time separately configured by the base station regardless of the reception time of the DCI. A plurality of candidate resources for the cell DTX active time may be configured, and one of the plurality of candidate resources may be dynamically indicated by DCI. Configuration information of the aperiodic cell DTX configuration may not include information on a periodicity value of the cell DTX active time, an on-duration, or the like.

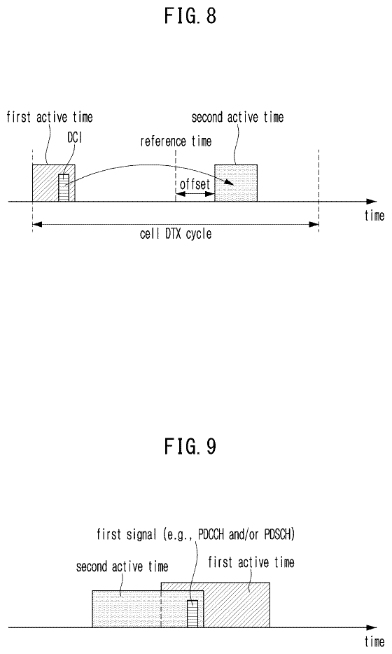

FIG. 8 is a conceptual diagram illustrating exemplary embodiments of a method of allocating an aperiodic cell DTX active time.

Referring to FIG. 8, DCI allocating an active time of an aperiodic cell DTX configuration may be transmitted in an active time of another cell DTX configuration. For example, a terminal may receive the DCI in the first active time of the first cell DTX configuration and may identify, based on the DCI, allocation information of the second active time of the second cell DTX configuration. In other words, the second active time of the second cell DTX configuration may be dynamically allocated to the terminal by the DCI. According to another exemplary embodiment, a separate time duration for monitoring the DCI by the terminal may be configured. The separate time duration may not belong to a cell DTX active time. Even when the separate time duration does not belong to a cell DTX active time, the terminal may exceptionally perform a PDCCH monitoring operation in the separate time duration to receive the DCI. A position of the second active time may be indicated by a time offset from a reference time. The DCI may be group-common DCI and may be transmitted to the terminal or a terminal group through a common search space (CSS) set (e.g., a Type 3-PDCCH CSS set). The DCI may be DCI format 2_9. According to the above-described exemplary embodiment, a remaining time duration may be opportunistically allocated in a beam footprint requiring transmission, and overall resource efficiency and transmission performance of a service area managed by a satellite node may increase.

According to another exemplary embodiment, an end time of the first active time may be fixed, and an end time of the second active time may be extended as needed. When a plurality of cell DTX configurations are configured for the terminal, whether to extend a cell DTX active time and/or whether to apply a timer may be applied in units of a cell DTX configuration. When terminal operations performed within the second active time satisfy a preconfigured condition (e.g., when the terminal receives scheduling DCI, when the terminal receives a PDSCH, or when the terminal transmits a PUSCH), the second active time may be extended. Extension of the active time may be based on a timer operation. When the terminal successfully receives DCI or a data channel in the active time, the terminal may start or reset a timer based on a reception time thereof. The terminal may enter an inactive time when the timer expires. A timer value may be decremented by a unit time starting from a configured value. When the timer value reaches a specific value (e.g., 0), the timer may expire. The terminal may perform a downlink reception operation in an extended active time in the same manner as an operation in an active time corresponding to an on-duration.

According to the above-described exemplary embodiment, a cell DTX active time may be terminal-specifically extended. When a plurality of terminals belonging to a beam footprint assume different durations as active times, implementation complexity of the base station may increase. In order to address the above problem, information indicating extension of a cell DTX active time may be included in common DCI or group-common DCI, and the common DCI or the group-common DCI may be commonly transmitted to the plurality of terminals. The common DCI or the group-common DCI may be received by RRC connected mode terminals, RRC idle mode terminals, and RRC inactive mode terminals. An RRC connected mode terminal may refer to a terminal operating in the RRC connected mode. An RRC idle mode terminal may refer to a terminal operating in the RRC idle mode. An RRC inactive mode terminal may refer to a terminal operating in the RRC inactive mode. The common DCI or the group-common DCI may be transmitted in a Type 0/0A/1/2-PDCCH CSS set and may be transmitted based on P-RNTI, SI-RNTI, RA-RNTI, or the like. Information on a length of an extended duration of the active time may be included in system information or cell-common configuration information, and the system information or the cell-common configuration information may be transmitted to the plurality of terminals.

According to another exemplary embodiment, the first active time (or the first cell DTX configuration) may be applied to terminals camping on or connected to the cell (or beam footprint) regardless of RRC states, and the second active time (or the second cell DTX configuration) may be applied to terminals in a specific RRC state (e.g., RRC connected mode terminals) belonging to the cell (or beam footprint). The base station may transmit common signal(s) and common channel(s) in the first dwell time for each beam footprint and may perform terminal-specific transmission (e.g., unicast transmission) in the second dwell time. In this case, it may be sufficient for a terminal in an RRC idle mode or an RRC inactive mode to transmit and receive a signal during the first dwell time and to operate in a sleep mode during the second dwell time. On the other hand, an RRC connected mode terminal may perform transmission and reception operations not only in the first dwell time but also in the second dwell time at least when traffic exists.

The above-described exemplary embodiments may be implemented in combination. For example, DCI indicating an activation/deactivation operation of a cell DTX configuration may include information on a position and/or a length of an active time (e.g., on-duration) of the cell DTX configuration together. In other words, the DCI may include information indicating an activation/deactivation operation of the cell DTX configuration and information on a position and/or a length of the active time (e.g., on-duration) of the cell DTX configuration. The DCI may be received by a terminal in a specific RRC state (e.g., RRC connected mode terminal). For example, an RRC idle/inactive mode terminal may not receive the DCI and may perform transmission and reception operations based only on a semi-statically configured cell DTX configuration and cell DTX active time.

Operational asymmetry between active times identified in the above-described exemplary embodiments may provide design criteria for methods of signaling configuration information of cell DTX configurations. Configuration information of the first active time may be included in system information or cell-common configuration information (e.g., cell-common RRC message) and may be transmitted to arbitrary terminals belonging to a cell (or a beam footprint), and configuration information of the second active time may be included in terminal-specific configuration information (e.g., terminal-specific RRC message) and may be transmitted to an RRC connected mode terminal. Alternatively, configuration information of the second active time may also be included in cell-common configuration information and may be equally applied to a plurality of terminals. However, the cell-common configuration information may be included in a terminal-specific RRC message and may be transmitted to a terminal based on a terminal-specific RRC signaling procedure. In this case, the configuration information of the first active time and the configuration information of the second active time may be included in different cell DTX configurations. One cell DTX configuration may be configured for an RRC idle/inactive mode terminal, and the RRC idle/inactive mode terminal may perform transmission and reception operations based on one active time formed by the one cell DTX configuration. In contrast, a plurality of cell DTX configurations may be configured for an RRC connected mode terminal, and the RRC connected mode terminal may perform transmission and reception operations based on a plurality of active times formed by the plurality of cell DTX configurations.

In order to guarantee camping and initial access operations of an RRC idle/inactive mode terminal, transmission of cell-common signals and cell-common channels may be restricted to only a specific active time. For example, the terminal may receive SSB, system information (e.g., SIB1, SIB0, SIB19, SIBx, or the like), and a paging message in the first active time. The terminal may transmit or receive UL/DL signals constituting a random access procedure in the first active time. For example, in the first active time, the terminal may transmit PRACH (e.g., Msg1 PRACH or MsgA PRACH) and Msg3 PUSCH and may receive RAR (e.g., PDSCH including RAR or PDCCH scheduling PDSCH including RAR) and Msg4 PDSCH. The terminal may receive paging early indication information, tracking reference signal (TRS), and/or CSI-RS configured for tracking purposes in the first active time in order to perform an improved paging operation. For convenience of description, a set of signals expected to be transmitted or received by the terminal in the first active time may be referred to as the first signal set, and a set of signals expected to be transmitted or received by the terminal in the second active time may be referred to as the second signal set. An intersection may exist between the first signal set and the second signal set.

FIG. 9 is a conceptual diagram illustrating exemplary embodiments of a signal transmission method based on overlapping cell DTX active times.

Referring to FIG. 9, a plurality of active times configured for a terminal may overlap each other. When on-durations of a plurality of active times are configured to overlap, when at least one active time among a plurality of active times is extended to include another active time, and/or when at least one active time among a plurality of active times is dynamically allocated to include another active time, the plurality of active times may overlap each other.

The plurality of active times may include the first active time and the second active time, and conditional extension for the second active time may be configured to be allowed. The terminal may transmit or receive a signal in a duration in which the plurality of active times overlap. The signal hereinafter referred to as a first signal may be included in both the first signal set and the second signal set. The first signal may be a signal satisfying an extension condition of the second active time. Transmission or reception of the first signal in a duration in which the plurality of active times overlap may be allowed. Allowance for transmission or reception of the first signal in the duration in which the plurality of active times overlap may be indicated to the terminal by signaling of a base station.

For example, the first signal may be PDCCH and/or PDSCH for transmitting a DL-shared channel (DL-SCH) or transport block (TB) to the terminal. The terminal receiving the first signal may have difficulty determining whether reception of the first signal is an operation according to the first active time or an operation according to the second active time. Accordingly, the terminal may have difficulty determining whether the terminal needs to extend the second active time according to reception of the first signal (e.g., whether the terminal needs to initialize an inactivity timer (e.g., a cell DTX inactivity timer or a DRX inactivity timer) of the second active time.

According to an exemplary embodiment for solving the above problem, whether to extend the second active time may be determined based on a type of the first signal or a signal set to which the first signal belongs. Specifically, when the first signal belongs only to the first signal set, the terminal may regard transmission or reception of the first signal as an operation according to the first active time and may not extend the second active time accordingly. For example, the first signal may include SSB or system information. Alternatively, the first signal may be a channel scheduling a transmission (e.g., transmission of system information). When the first signal belongs only to the second signal set, the terminal may regard transmission or reception of the first signal as an operation according to the second active time and may extend the second active time accordingly. For example, the first signal may be a PDSCH including a DL-SCH or TB or a PDCCH (or DCI) scheduling the PDSCH. When the first signal belongs to both the first signal set and the second signal set, the terminal may not distinguish which active time transmission or reception of the first signal is according to and may extend the second active time accordingly. As another method, when the first signal belongs to both the first signal set and the second signal set, the terminal may regard transmission or reception of the first signal as an operation according to the second active time and may extend the second active time accordingly. Alternatively, the terminal may not perform an operation of extending the active time when the ambiguity is not resolved.

According to another exemplary embodiment, when the terminal transmits or receives the first signal in the duration in which the first active time and the second active time overlap, the terminal may extend the second active time regardless of a type of the first signal or an inclusion relationship between the first signal and a signal set. In other words, regardless of whether the first signal is included in the first active time, the terminal may extend the second active time when the first signal is included in the second active time. Alternatively, when the terminal transmits or receives the first signal in the duration in which the first active time and the second active time overlap, the terminal may not extend the second active time regardless of a type of the first signal or an inclusion relationship between the first signal and a signal set.

According to another exemplary embodiment, a priority between the active times may be defined or configured, and whether to extend the second active time according to transmission or reception of the first signal may be determined based on the priority. The terminal may regard a transmission operation or a reception operation of the first signal as being based on an active time having a higher priority. When a priority of the second active time is higher than a priority of the first active time, the second active time may be extended.

According to another exemplary embodiment for solving the above problem, overlapping of a plurality of active times may not be allowed. Specifically, the terminal may not expect a plurality of on-durations corresponding to a plurality of active times to be configured to overlap. In addition to or alternatively to the above-described exemplary embodiment, the terminal may not expect an active time dynamically or aperiodically allocated to overlap another active time and/or an extended duration of an active time to overlap another active time. Several methods for avoiding overlap of active times are described below.

According to an exemplary embodiment, the second active time may be forcibly terminated at a reference time. The reference time may be a specific time with respect to the first active time. For example, the reference time may be a start time of the first active time. Alternatively, the reference time may refer to a time derived (e.g., determined) from the start time of the first active time according to a predefined rule. As another method, the terminal may receive information on the reference time based on a signaling procedure from the base station. In other words, the reference time may be configured by the base station. The reference time may be configured for one cell DTX configuration (e.g., cell DTX configuration corresponding to the second active time), and the reference time may be expressed by a time offset within a cell DTX cycle of the cell DTX configuration. The reference time may be a time outside the second active time. The terminal may stop or expire an inactivity timer of the second active time at the reference time and may terminate the second active time based on the reference time. The above-described operation may correspond to the exemplary embodiment of FIG. 4. For example, the reference time may be configured as a time within the remaining time duration (e.g., end time of the remaining time duration) illustrated in the exemplary embodiment of FIG. 4.

According to another exemplary embodiment, a resource pool for the second active time (e.g., time resource pool) may be configured.

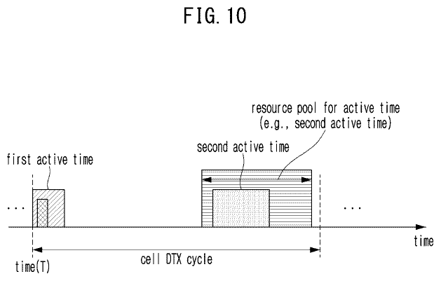

FIG. 10 is a conceptual diagram illustrating exemplary embodiments of a method of configuring a resource pool for a cell DTX active time.

Referring to FIG. 10, a terminal may receive configuration information of a plurality of active times including the first active time and the second active time. In other words, the plurality of active times may be configured for the terminal. In this case, a resource pool for the second active time may be configured. The second active time may be extended within the resource pool, and the second active time may be terminated when the second active time reaches an end time of the resource pool. Extension of the second active time may be allowed only within the resource pool. In other words, a cell DTX operation corresponding to the second active time may be deactivated in a duration outside the resource pool. The resource pool may include or may not include an on-duration of the second active time. When the resource pool does not include an on-duration of the second active time, the resource pool may be interpreted as a duration allowed only for extension of the second active time. The above-described operation may correspond to the exemplary embodiment of FIG. 4. For example, the resource pool may be configured to include at least part of the remaining time duration illustrated in the exemplary embodiment of FIG. 4. The end time of the resource pool may be configured as a time within the remaining time duration (e.g., an end time of the remaining time duration).

The resource pool may also be used to allocate an active time of an aperiodic cell DTX configuration. The aperiodic cell DTX active time may be allocated within the resource pool. A position of the aperiodic cell DTX active time may be expressed with a time offset from a start time of the resource pool and may be indicated to the terminal. The resource pool may be part of cell DTX configuration information and may be configured for the terminal. In other words, the cell DTX configuration information may include configuration information of the resource pool. In this case, a repetition periodicity of the resource pool may coincide with a cycle of the cell DTX configuration.

According to another exemplary embodiment, a maximum extension time of the second active time may be configured for the terminal. When a length of an extended duration of the second active time reaches the maximum extension time, the terminal may terminate the second active time and may enter an inactive time. According to another exemplary embodiment, the base station may transmit, to the terminal, a signaling message indicating termination of the active time. The signaling message may be a MAC CE or DCI. When the signaling message is DCI, group-common DCI may be used for simultaneous indication to a plurality of terminals. The terminal may terminate the second active time based on the signaling message received from the base station.

A unit of the cell DTX configuration may vary according to the above-described cell deployment scenario. In the first scenario, one satellite beam corresponds to one cell, and thus the cell DTX configuration may be configured cell-specifically. In this case, the terminal may receive one or more cell DTX configurations for a cell in which the terminal camps or connects. In the second scenario, a plurality of satellite beams are included in one cell, and thus the cell DTX configuration may be configured beam-specifically. For example, within one cell, the cell DTX configuration may be configured for each satellite beam (e.g., each SSB beam).

For one cell, a plurality of cell DTX configurations may be configured, and a resource (e.g., QCL source resource) having a QCL relationship with a reception signal of the terminal for each cell DTX configuration may be configured. Alternatively, one cell DTX configuration may include a plurality of QCL source resources. A QCL source resource may be limited to an SSB resource. Alternatively, a QCL source resource may further include a CSI-RS resource. SSBs that are QCL source signals may correspond one-to-one to cell DTX active times, and the SSBs may correspond to different SSB resources. The SSBs may refer to SSBs configured to be actually transmitted to the terminal (e.g., SSBs configured by an RRC parameter ssb-PositionsInBurst).

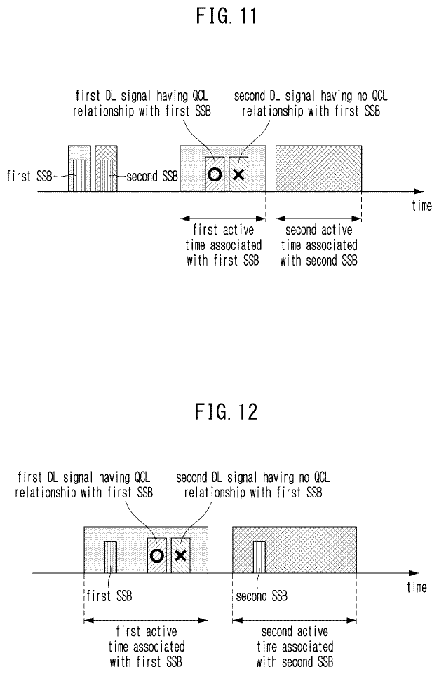

FIG. 11 is a conceptual diagram illustrating a first exemplary embodiment of a beam-specific cell DTX configuration method, and FIG. 12 is a conceptual diagram illustrating a second exemplary embodiment of a beam-specific cell DTX configuration method.

Referring to FIG. 11 and FIG. 12, a terminal may receive, from a base station, configuration information of a plurality of cell DTX active times for one cell, and each cell DTX active time may be associated with an SSB. The first active time may be associated with a first SSB, and the second active time may be associated with a second SSB. The first SSB and the second SSB may be QCL source signals of signals received or transmitted by the terminal in the first active time and the second active time, respectively. The terminal may assume that a DL signal (e.g., a first DL signal illustrated in FIG. 11 and/or FIG. 12) to be received in the first active time (or the second active time) has a QCL relationship with the first SSB (or the second SSB), and the terminal may receive the DL signal based on the assumption. The terminal may assume that a UL signal to be transmitted in the first active time (or the second active time) has a QCL relationship with the first SSB (or the second SSB), and the terminal may transmit the UL signal based on the assumption.

In the above exemplary embodiment, the terminal may expect to receive a DL signal having a QCL relationship with the first SSB (or the second SSB) in the first active time (or the second active time). In other words, all DL signals transmitted in the first active time (or the second active time) may have the first SSB (or the second SSB) as a QCL source signal. The terminal may transmit a UL signal having a QCL relationship with the first SSB (or the second SSB) in the first active time (or the second active time). In other words, all UL signals transmitted in the first active time (or the second active time) may have the first SSB (or the second SSB) as a QCL source signal. Alternatively, a QCL source signal applied to UL transmission in each active time may be a signal different from SSB, and the QCL source signal (e.g., another signal) may be configured for the terminal through a separate signaling procedure. In addition to the above-described exemplary embodiment, the terminal may not expect to receive a DL signal (e.g., a second DL signal illustrated in FIG. 11 and/or FIG. 12) not having a QCL relationship with the first SSB (or the second SSB) in the first active time (or the second active time). The terminal may not expect to transmit a UL signal not having a QCL relationship with the first SSB (or the second SSB) in the first active time (or the second active time). When a DL signal or a UL signal having a QCL relationship with the first SSB (or the second SSB) is mapped to a duration outside the first active time (or the second active time), the terminal may omit a reception operation of the DL signal or a transmission operation of the UL signal.

In the present disclosure, an expression that a DL signal or a UL signal has a QCL relationship with an SSB may mean not only that the DL signal or the UL signal directly has the SSB as a QCL source signal but also that the DL signal or the UL signal has, as a QCL source signal, another signal (e.g., CSI-RS or SRS) having the SSB as a QCL source signal. In other words, a chain rule may be applied to the QCL relationships between signals.

Exceptionally, the above-described operation may not be applied to some signals. For example, some signals may include SSB. In the exemplary embodiment of FIG. 11, the first SSB (or the second SSB) may be transmitted in a duration outside the first active time (or the second active time), and the terminal may receive the first SSB (or the second SSB). The terminal may consider a resource region in which an SSB that is a QCL source signal is transmitted as an active time and may receive the SSB based on the consideration. SSBs transmitted in the same cell (e.g., the first SSB and the second SSB) may be mapped by being localized within a half radio frame. In the exemplary embodiment of FIG. 12, the first SSB (or the second SSB) may be transmitted within the first active time (or the second active time) like other signals. In other words, the SSB may be transmitted within an active time associated with the SSB. In this case, a limitation that SSBs transmitted in the same cell (e.g., the first SSB and the second SSB) need to be mapped within a half radio frame may not be applied. A resource distance between the SSBs (e.g., a symbol distance and a slot distance) may be larger than a half radio frame.

The resource configuration methods and the terminal operations based on a plurality of cell DTX active times or a plurality of cell DRX active times may be applied for each beam. For each satellite beam (or each QCL source signal or each SSB), a plurality of active times may be configured. For example, for a first SSB, the first active time and the second active time may be configured, and for a second SSB, the first active time and the second active time may be configured. In this case, a total of four active times may be configured for the terminal. The terminal may select one satellite beam (e.g., one SSB) for one cell. Alternatively, one satellite beam (e.g., one SSB) may be configured for the terminal for one cell. In this case, the terminal may perform the above-described signal transmission and reception operations based on the one satellite beam (e.g., one SSB) in active time(s) associated with the one satellite beam (e.g., one SSB). As another method, the terminal may select a plurality of satellite beams (e.g., a plurality of SSBs) for one cell. Alternatively, a plurality of satellite beams (e.g., a plurality of SSBs) may be configured for the terminal for one cell. In this case, the terminal may perform the above-described signal transmission and reception operations based on the plurality of satellite beams (e.g., the plurality of SSBs) in active time(s) associated with the plurality of satellite beams (e.g., the plurality of SSBs).

The cell DTX operation of the terminal may be dynamically activated or deactivated by a dynamic signaling procedure from the base station (e.g., DCI and MAC CE). Alternatively, a cell DTX active time of the terminal may be dynamically allocated by a dynamic signaling procedure from the base station (e.g., DCI and MAC CE). In this case, indication information included in the DCI or MAC CE may include a beam index (or a resource index). The beam index may be an index of a QCL source signal (e.g., an SSB index or a CSI-RS resource index). In addition to or alternatively to the above-described exemplary embodiment, when a plurality of cell DTX configurations and/or a plurality of cell DTX active times are configured for the terminal, indication information included in the DCI or MAC CE may include a cell DTX configuration index and/or a cell DTX active time index. The terminal may identify a cell DTX configuration and/or a cell DTX active time to which the dynamic activation/deactivation indication or active time indication is applied based on the index and may perform an operation according to the identified cell DTX configuration and/or the identified cell DTX active time.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner. The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, information indicating a first discontinuous transmission (DTX) active time;
receiving, from the base station, information indicating a second DTX active time; and
performing communication with the base station based on at least one of the first DTX active time or the second DTX active time.

2. The method of claim 1, wherein the first DTX active time is configured periodically, and the second DTX active time is configured aperiodically.

3. The method of claim 1, wherein the second DTX active time is opportunistically allocated by dynamic signaling of the base station.

4. The method of claim 1, wherein the information indicating the second DTX active time is included in downlink control information (DCI) received from the base station, and the information indicating the second DTX active time includes at least one of a start time, a duration, or an end time of the second DTX active time.

5. The method of claim 1, wherein an end time of the second DTX active time is extended as needed.

6. The method of claim 1, wherein the first DTX active time and the second DTX active time are applied in different radio resource control (RRC) states, and each of the different RRC states is an RRC idle mode, an RRC inactive mode, or an RRC connected mode.

7. The method of claim 1, wherein the terminal in an RRC connected mode applies the second DTX active time, and the terminal in an RRC idle mode or an RRC inactive mode does not apply the second DTX active time.

8. The method of claim 1, wherein the performing of the communication with the base station comprises: transmitting and receiving, with the base station, a first signal allowed for one of the first DTX active time or the second DTX active time, during an overlapped time between the first DTX active time and the second DTX active time.

9. The method of claim 1, wherein the first DTX active time does not overlap with the second DTX active time, the second DTX active time is terminated at a reference time, and the reference time is determined based on a specific time for the first DTX active time.

10. The method of claim 1, wherein the first DTX active time does not overlap with the second DTX active time, a resource pool for the second DTX active time is configured, the second DTX active time is activated within the resource pool, and the second DTX active time is deactivated outside the resource pool.

11. A method of a base station, comprising:
transmitting, to a terminal, information indicating a first discontinuous transmission (DTX) active time;
transmitting, to the terminal, information indicating a second DTX active time; and
performing communication with the terminal based on at least one of the first DTX active time or the second DTX active time.

12. The method of claim 11, wherein the first DTX active time is configured periodically, and the second DTX active time is configured aperiodically.

13. The method of claim 11, wherein the second DTX active time is opportunistically allocated to the terminal by dynamic signaling of the base station.

14. The method of claim 11, wherein the information indicating the second DTX active time is included in downlink control information (DCI) transmitted by the base station, and the information indicating the second DTX active time includes at least one of a start time, a duration, or an end time of the second DTX active time.

15. The method of claim 11, wherein an end time of the second DTX active time is extended as needed.

16. The method of claim 11, wherein the first DTX active time and the second DTX active time are applied in different radio resource control (RRC) states, and each of the different RRC states is an RRC idle mode, an RRC inactive mode, or an RRC connected mode.

17. The method of claim 11, wherein the second DTX active time is applied to the terminal in an RRC connected mode, and the second DTX active time is not applied to the terminal in an RRC idle mode or an RRC inactive mode.

18. The method of claim 11, wherein the performing of the communication with the terminal comprises: transmitting and receiving, with the terminal, a first signal allowed for one of the first DTX active time or the second DTX active time, during an overlapped time between the first DTX active time and the second DTX active time.

19. The method of claim 11, wherein the first DTX active time does not overlap with the second DTX active time, the second DTX active time is terminated at a reference time, and the reference time is determined based on a specific time for the first DTX active time.

20. The method of claim 11, wherein the first DTX active time does not overlap with the second DTX active time, a resource pool for the second DTX active time is configured, the second DTX active time is activated within the resource pool, and the second DTX active time is deactivated outside the resource pool.
